(19) United States
(12) Patent Application Publication
(10) Pub. No.: US 2026/0195197 A1
(43) Pub. Date: Jul. 9, 2026

(54) SYNCHRONIZATION BLOCK

(71) Applicant: Microsoft Technology Licensing, LLC, Redmond, WA (US)

(72) Inventors: Richard William DOING, Raleigh, NC (US); Chulian ZHANG, Sunnyvale, CA (US); Lu WAN, San Jose, CA (US); James Oscar TINGEN, Raleigh, NC (US); Xiaoling XU, Cupertino, CA (US); George PETRE, Redmond, WA (US); Thomas Craig SAVELL, Emeryville, CA (US); Andrew Alan PFEIFER, Cary, NC (US)

(73) Assignee: Microsoft Technology Licensing, LLC, Redmond, WA (US)

(21) Appl. No.: 19/012,543

(22) Filed: Jan. 7, 2025

(51) Int. Cl. G06F 9/52; G06F 15/78

(52) U.S. Cl. CPC G06F 9/52; G06F 15/7825

(57) ABSTRACT

A computing device including a system-on-a-chip (SoC). The SoC includes a plurality of logic circuit blocks, including synchronization blocks and hardware accelerator blocks. A synchronization block is configured to receive a wait request from a first hardware accelerator block. The wait request includes one or more semaphores and one or more wait threshold values. The synchronization block is configured to store the wait request. The synchronization block is configured to receive, from a signal source block, a signal request that indicates a semaphore included among the one or more semaphores in the wait request. In response to receiving the signal request, the synchronization block is configured to update the semaphore. The synchronization block is configured to determine that the updated value of the semaphore has reached the wait threshold value and to transmit a wait completion response to at least the first hardware accelerator block.

### BACKGROUND

High-performance computing hardware devices, such as accelerators developed for machine learning applications, make use of arrays of logic circuits that are specialized for efficient performance of specific computing operations. An array of logic circuits is configured to perform multiple copies of the computing operation in parallel, thereby allowing for faster and more efficient performance of a computing process that includes multiple instances of that operation. For example, specific operations on data stored in a matrix or vector format may be parallelized by performing multiple instances of the operation in parallel on different elements or regions of the matrix or vector. Since computing tasks such as machine learning model training and inferencing typically include large numbers of such computations, using a specialized hardware accelerator can significantly increase the time- and energy-efficiency of those computing tasks.

### SUMMARY

According to one aspect of the present disclosure, a computing device is provided, including a system-on-a-chip (SoC). The SoC includes a plurality of logic circuit blocks. The plurality of logic circuit blocks include a plurality of synchronization blocks and a plurality of hardware accelerator blocks arranged in a synchronization network. A synchronization block of the plurality of synchronization blocks is configured to receive a wait request from a first hardware accelerator block of the plurality of hardware accelerator blocks over the synchronization network. The wait request includes one or more semaphores and one or more wait threshold values respectively associated with the one or more semaphores. The synchronization block is further configured to store the wait request. Over the synchronization network, the synchronization block is further configured to receive, from a signal source block of the plurality of logic circuit blocks, a signal request that indicates a semaphore included among the one or more semaphores in the wait request. In response to receiving the signal request, the synchronization block is further configured to update a value of the semaphore. The synchronization block is further configured to determine that the updated value of the semaphore has reached the wait threshold value. In response to determining that the updated value of the semaphore has reached the wait threshold value, the synchronization block is further configured to transmit a wait completion response to at least the first hardware accelerator block over the synchronization network.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 schematically shows a computing device including a system-on-a-chip (SoC), according to one example embodiment.

FIG. 2A schematically shows a synchronization block included in the SoC, according to the example of FIG. 1.

FIG. 2B schematically shows local processing regions of the SoC that include respective synchronization blocks and hardware accelerator blocks, according to the example of FIG. 2A.

FIGS. 3A-3C show example timelines of requests and responses that are transmitted to and from a synchronization block, according to the example of FIG. 2A.

FIG. 4A schematically shows a synchronization block and a first hardware accelerator block in an example in which the first hardware accelerator block transmits a blocking wait request to the synchronization block, according to the example of FIG. 2A.

FIG. 4B schematically shows a synchronization block and a first hardware accelerator block in an example in which the first hardware accelerator block transmits a nonblocking wait request to the synchronization block, according to the example of FIG. 2A.

FIG. 4C schematically shows a synchronization block and a first hardware accelerator block in an example in which the first hardware accelerator block transmits a polling wait request to the synchronization block, according to the example of FIG. 2A.

FIG. 5 schematically shows the SoC in an example in which the synchronization block includes a watchdog timer, according to the example of FIG. 2A.

FIG. 6A schematically shows the synchronization block in an example in which the synchronization block is configured to process incoming wait requests at a weighted round-robin arbitration protocol, according to the example of FIG. 2A.

FIG. 6B schematically shows the synchronization block in an example in which the synchronization block is configured to process outgoing signal requests at a weighted round-robin arbitration protocol, according to the example of FIG. 2A.

FIG. 7 schematically shows the SoC in an example in which the synchronization block is further configured to receive a breakpoint definition, according to the example of FIG. 2A.

FIG. 8A shows a flowchart of a method for use with a computing system that includes an SoC, according to the example of FIG. 1.

FIGS. 8B-8H show additional steps of the method of FIG. 8A that may be performed in some examples.

FIG. 9 shows a schematic view of an example computing environment in which the computing device of FIG. 1 may be instantiated.

### DETAILED DESCRIPTION

Some specialized computing hardware devices include multiple hardware accelerators. These hardware accelerators may be configured to efficiently perform different computing operations. Thus, the hardware accelerators included in the device may be configured to accelerate multiple different stages in a processing pipeline that are frequently performed together. Multiple instances of a hardware accelerator may also be included in the device. The specialized computing hardware device may, for example, be a system-on-a-chip (SoC), as discussed in further detail below.

When a processing pipeline is executed at a device that includes multiple hardware accelerators, input-output scheduling is performed for those hardware accelerators. For example, when one of the hardware accelerators takes the output of another hardware accelerator as input, the first hardware accelerator may have to wait for the second hardware accelerator to finish computing that output. The hardware accelerators may accordingly be synchronized such that the inputs and outputs of the hardware accelerators follow the specified temporal sequence of the processing pipeline, and such that the operations performed at the hardware accelerators have valid and up-to-date inputs.

In existing SoCs that include multiple hardware accelerators, synchronization of those hardware accelerators is handled at the software level. For example, this software may be executed on a control processor of the SoC. The software that handles hardware accelerator synchronization for existing SoCs uses data structures referred to as semaphores in synchronization-related instructions that are conveyed to the hardware accelerators. However, different hardware accelerators frequently handle the semaphores according to different protocols. The protocol differences may require additional processing to be performed at the synchronization software to translate between protocols, thereby slowing down execution of the processing pipeline. These differences in semaphore protocols may also make hardware accelerator synchronization more prone to software errors and may make those errors more difficult to correct.

When existing SoCs handle synchronization at the control processor, communication between the hardware accelerators and the control processor may incur significant amounts of latency. This latency may occur when the control processor acts as a bottleneck for the processing of semaphores.

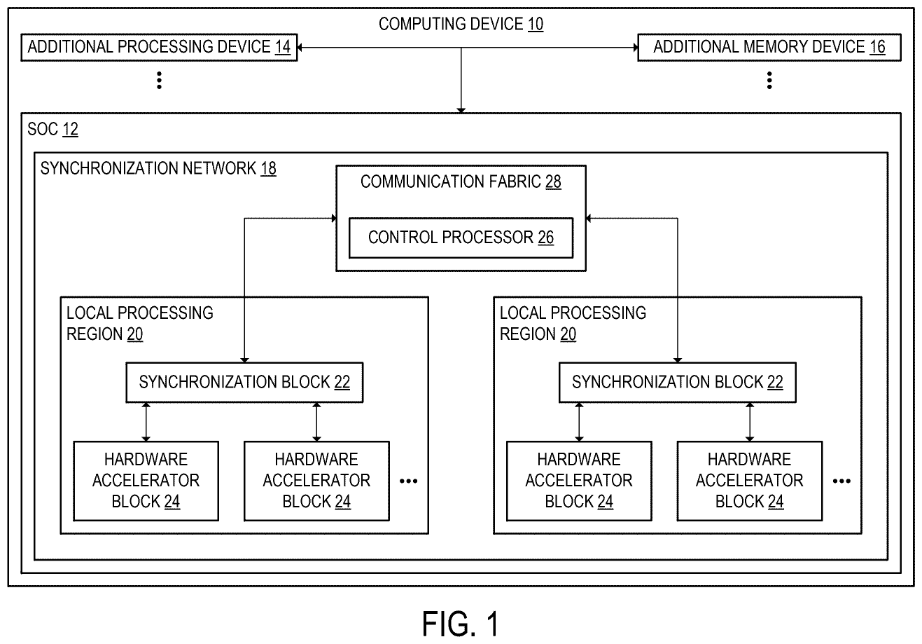

In order to address the above challenges, a computing device 10 is provided, as shown in the example of FIG. 1. The computing device 10 shown in FIG. 1 includes an SoC 12. The SoC 12 includes a plurality of logic circuit blocks, which include a plurality of synchronization blocks 22 and a plurality of hardware accelerator blocks 24 arranged in a synchronization network 18 within the SoC 12. In addition to the SoC 12, the computing device 10 includes one or more additional processing devices 14 and one or more additional memory devices 16.

In the example of FIG. 1, the SoC 12 includes a plurality of local processing regions 20. Each local processing region 20 includes a respective synchronization block 22 of the plurality of synchronization blocks 22. In addition, each local processing region 20 includes a respective plurality of local hardware accelerator blocks 24 coupled to the synchronization block 22 of that local processing region 20. The local processing regions 20 are coupled to each other via the synchronization blocks 22. Thus, the synchronization blocks 22 and the hardware accelerator blocks 24 are arranged in a synchronization network 18. The synchronization network 18 of the SoC 12 shown in FIG. 1 further includes a control processor 26. The control processor 26 is included in a communication fabric 28 via which the local processing regions 20 are configured to communicate with each other. In some examples, additional hardware components of the SoC 12 not shown in FIG. 1 may also be configured to communicate with other hardware components over the communication fabric 28.

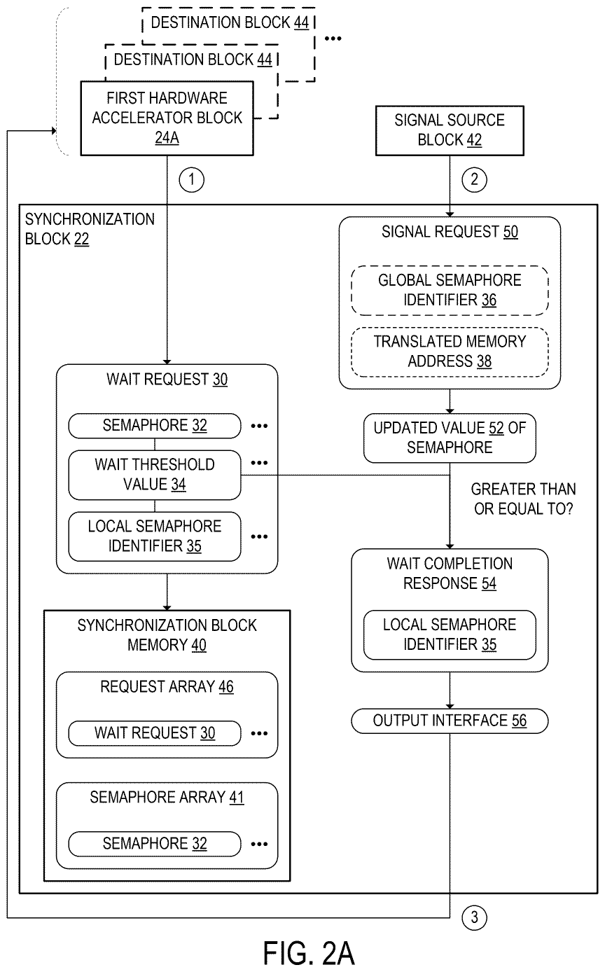

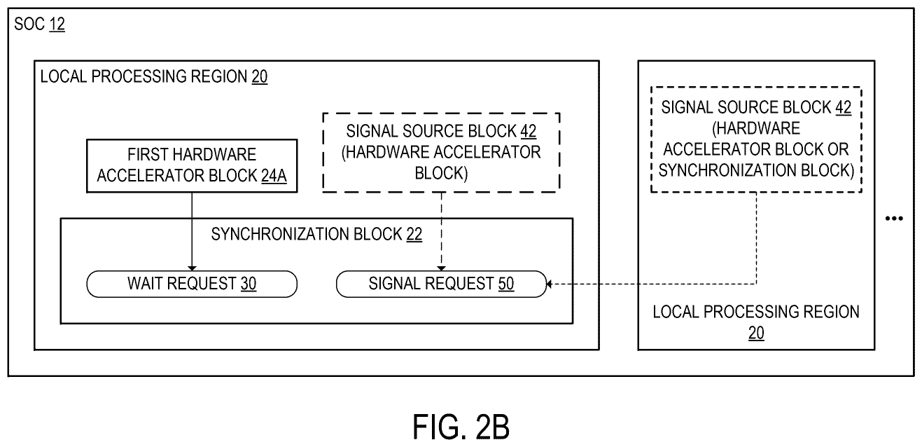

FIG. 2A schematically shows the synchronization block 22 in additional detail, according to one example. At step 1, according to the example of FIG. 2A, the synchronization block 22 is configured to receive a wait request 30. The wait request 30 is received over the synchronization network 18 from a first hardware accelerator block 24A of the plurality of hardware accelerator blocks 24. The wait request 30 is a request from the first hardware accelerator block 24A for the synchronization block 22 to output a wait completion response 54 after one or more conditions have been fulfilled, as discussed in further detail below.

The wait request 30 includes one or more semaphores 32. Each of the semaphores 32 may, for example, be an integer-valued counter. In addition, the wait request 30 includes one or more wait threshold values 34 respectively associated with the one or more semaphores 32. Each of the wait threshold values 34 may also be integer-valued.

In the example of FIG. 2A, the wait request 30 specifies the one or more semaphores 32 using one or more local semaphore identifiers 35 respectively associated with the one or more semaphores 32. Each of the one or more local semaphore identifiers 35 is unique within the local processing region 20 in which the synchronization block 22 is located. Thus, when the synchronization blocks 22 send and receive the semaphores 32 to and from the hardware accelerator blocks 24 included in the same local processing region 20, the semaphores 32 are distinguishable from each other according to their local semaphore identifiers 35. This uniqueness may prevent errors in hardware accelerator synchronization that would otherwise occur due to treating different semaphores 32 as the same semaphore.

The synchronization block 22 is further configured to store the wait request 30 in a request array 46. The wait request 30 is stored in synchronization block memory 40 included in the synchronization block 22. In some examples, the synchronization block memory 40 may also store a semaphore array 41 in which the one or more semaphores 32 are stored separately from the wait request 30.

At step 2, subsequently to storing the wait request 30, the synchronization block 22 is further configured to receive a signal request 50 over the synchronization network 18. The synchronization block 22 receives the signal request 50 from a signal source block 42 of the plurality of logic circuit blocks. The signal source block 42 may be a hardware accelerator block 24 or another synchronization block 22. The signal request 50 indicates a semaphore 32 included among the one or more semaphores 32 in the wait request 30.

In some examples, as shown in FIG. 2A, the synchronization block 22 is further configured to store one or more global semaphore identifiers 36 associated with the one or more semaphores 32, in addition to the one or more local semaphore identifiers 35. Each of the one or more global semaphore identifiers 36 is unique across the plurality of local processing regions 20. In the example of FIG. 2A, the signal request 50 specifies the semaphore 32 using the global semaphore identifier 36 of that semaphore 32. Thus, the semaphores 32 specified in signal requests 50 are distinguishable from each other even when those signal requests 50 are received from a different local processing region 20. By utilizing both local semaphore identifiers 35 and global semaphore identifiers 36, the synchronization block 22 may define local semaphores within local processes while also being able to define global semaphores. Different computing processes executed at different local processing regions 20 may retrieve and update the global semaphores without having to transmit the values of the global semaphores using function calls executed at the control processor 26.

In examples in which the signal source block 42 is located in a different local processing region 20 from the synchronization block 22, the signal request 50 may include a translated memory address 38 instead of the global semaphore identifier 36. The translated memory address 38 may be an address within the synchronization block memory 40 at which a specific semaphore 32 is stored. As discussed below, the translated memory address 38 may be computed from a global semaphore identifier 36 and may therefore uniquely specify the semaphore 32.

In previous approaches to hardware accelerator synchronization, memory address translation is handled in software at the control processor 26. However, performing memory address translation at the control processor 26 may have high computational overhead and may lead to control processor oversubscription. Moving memory address translation to the synchronization block 22 may therefore increase the efficiency of communication between the hardware accelerator blocks 24. In addition, moving memory address translation to the synchronization block 22 may reduce the complexity of programming the SoC 12.

In response to receiving the signal request 50, the synchronization block 22 is further configured to update a value of the semaphore 32. In examples in which the semaphore 32 is a counter, the synchronization block 22 may be configured to update the value of the semaphore 32 by incrementing the semaphore 32. Alternatively, the synchronization block 22 may be configured to decrement the semaphore 32. In examples in which multiple semaphores 32 are stored at the synchronization block 22, the synchronization block 22 may be configured to determine which semaphore 32 to update according to the global semaphore identifier 36 included in the signal request 50.

The synchronization block 22 is further configured to compare the updated value 52 of the semaphore 32 to the wait threshold value 34 included in the wait request 30. When the updated value 52 is below the wait threshold value 34 in examples in which the semaphore 32 is a counter that counts up, or above the wait threshold value 34 in examples in which the semaphore 32 is a counter that counts down, the synchronization block 22 is configured to wait for one or more additional signal requests 50 before sending the wait completion response 54. At step 3, when the synchronization block 22 instead determines that the updated value 52 of the semaphore 32 has reached the wait threshold value 34, the synchronization block 22 is further configured to transmit the wait completion response 54 to at least the first hardware accelerator block 24A over the synchronization network 18. Thus, the first hardware accelerator block 24A is notified that the requested wait has concluded. The wait completion response 54 may include the local semaphore identifier 35 of the semaphore 32 in order to specify which semaphore 32 has completed its requested wait.

The synchronization block 22 may be configured to transmit the wait completion response 54 within the local processing region 20 in which the synchronization block 22 is located. The synchronization block 22 may be configured to output the wait completion response 54 only to the first hardware accelerator block 24A or may alternatively be configured to output respective copies of the wait completion response 54 to a plurality of destination blocks 44 included in the local processing region 20. The first hardware accelerator block 24A is included among the plurality of destination blocks 44 in the example of FIG. 2A.

FIG. 2B schematically shows example locations of the first hardware accelerator block 24A and the signal source block 42. As discussed above, each of the synchronization blocks 22 is eligible to receive the wait request 30 from within the local processing region 20 of that synchronization block 22. However, according to the example of FIG. 2B, each synchronization block 22 is not eligible to receive wait requests 30 from outside the local processing region 20 of the synchronization block 22. Since the synchronization blocks 22 are indirectly coupled, through one or more other synchronization blocks 22, to the hardware accelerator blocks 24 outside their respective local processing regions 20, waiting on semaphores 32 across different local processing regions 20 would incur additional communication overhead and would increase the idle time of one or more of the hardware accelerator blocks 24. Thus, the synchronization blocks 22 in the example of FIG. 2B do not transmit wait requests 30 between different local processing regions 20.

In the example of FIG. 2B, each of the synchronization blocks 22 is eligible to receive the signal request 50 from within the local processing region 20 of the synchronization block 22 and from outside the local processing region 20 of the synchronization block 22. The signal source block 42 may accordingly be a hardware accelerator block 24 located inside the local processing region 20 or a hardware accelerator block 24 or synchronization block 22 located outside the local processing region 20. In contrast to waiting on a semaphore 32, transmitting a signal request 50 between local processing regions 20 does not result in significant amounts of additional waiting at the synchronization blocks 22 or hardware accelerator blocks 24.

Although, in the example of FIG. 2A, the synchronization block 22 receives the wait request 30 before the signal request 50, the synchronization block 22 may instead receive the signal request 50 prior to the wait request 30 in some examples. The signal request 50 may be stored in the synchronization block memory 40. In such examples, the synchronization block 22 may be further configured to update the semaphore 32 indicated in the signal request 50 in response to receiving the wait request 30.

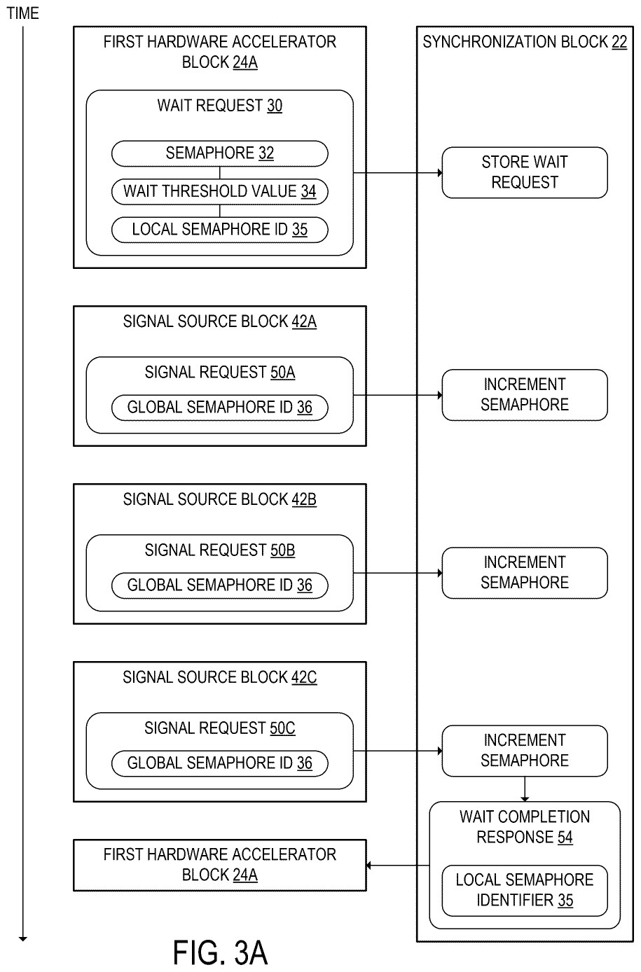

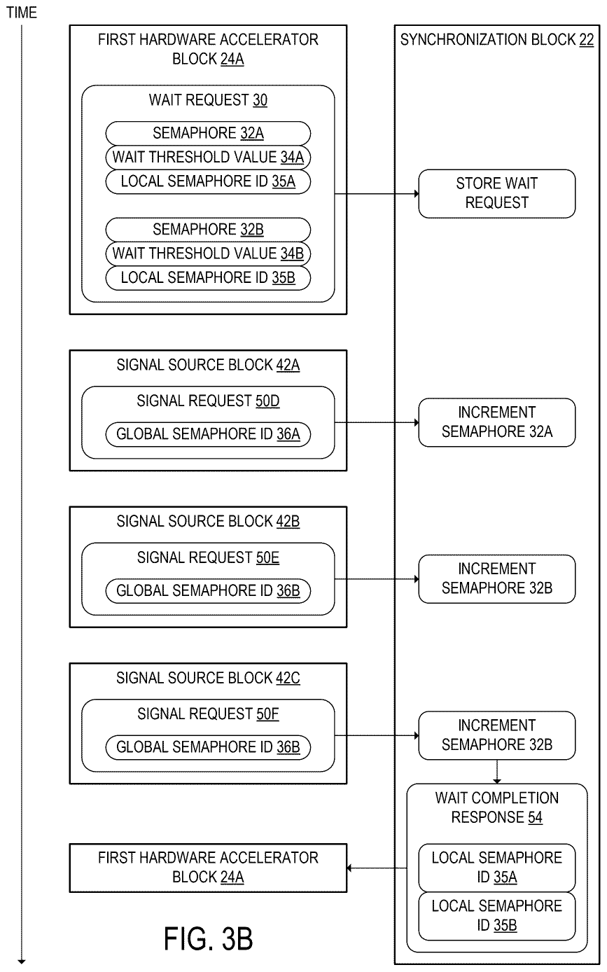

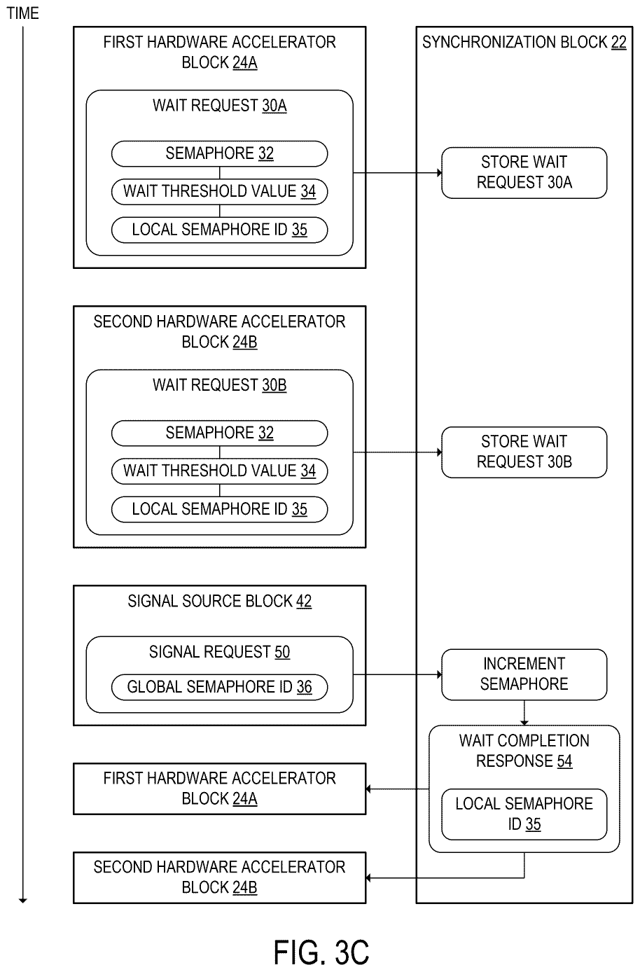

FIGS. 3A-3C show example timelines of requests and responses that are transmitted to and from a synchronization block 22. In the example of FIG. 3A, the first hardware accelerator block 24A transmits a wait request 30 to the synchronization block 22, including one semaphore 32 and its corresponding wait threshold value 34 and global semaphore identifier 36. In the example wait request 30 of FIG. 3A, the semaphore is initialized with a value of 0 and the wait threshold value is equal to 3.

The synchronization block 22 is further configured to receive signal requests 50A, 50B, and 50C that each include the global semaphore identifier 36 of the semaphore 32 included in the wait request 30. The signal requests 50A, 50B, and 50C are received from three different signal source blocks 42A, 42B, and 42C in the example of FIG. 3A. The synchronization block 22 is further configured to increment the semaphore 32 in response to receiving each of these signal requests 50A, 50B, and 50C. When the semaphore 32 is incremented in response to receiving the signal request 50C, the semaphore 32 reaches the wait threshold value 34. The synchronization block 22 is accordingly configured to transmit a wait completion response 54 to the first hardware accelerator block 24A.

In the example of FIG. 3B, the wait request 30 includes two semaphores 32A and 32B. The wait request 30 further includes respective wait threshold values 34A and 34B of the semaphores 32A and 32B. The wait threshold values 34A is set to 1 in the example of FIG. 3B, and the wait threshold value 34B is set to 2. In addition, the wait request 30 includes respective local semaphore identifiers 35A and 35B associated with the semaphores 32A and 32B.

The synchronization block 22 shown in the example of FIG. 3B is further configured to receive a signal request 50D from a signal source block 42A. The signal request 50D is a request to update the semaphore 32A, which the signal request 50D specifies by including a global semaphore identifier 36A. The global semaphore identifier 36A is an identifier of the semaphore 32A. The synchronization block 22 is configured to increment the semaphore 32A in response to receiving the signal request 50D. Although the semaphore 32A has reached its wait threshold value 34A, the other semaphore 32B included in the wait request 30 has not yet reached the wait threshold value 34B. The synchronization block 22 therefore delays transmitting a wait completion response 54 until both semaphores 32 have reached their wait threshold values 34.

The synchronization block 22 is further configured to receive a signal request 50E from a signal source block 42B. The signal source block 42B may be the same logic circuit block as the signal source block 42A or may alternatively be a different logic circuit block. The signal request 50E includes a global semaphore identifier 36B associated with the semaphore 32B. Thus, the synchronization block 22 is configured to increment the semaphore 32B in response to receiving the signal request 50E. Since the semaphore 32B has not yet reached its wait threshold value 34B after this update, the synchronization block 22 delays transmission of a wait completion response 54 again.

The synchronization block 22 is further configured to receive a signal request 50F from a signal source block 42C. The signal request 50F includes the global semaphore identifier 36B of the semaphore 32B. This update brings the value of the semaphore 32B to its wait threshold value 34B. Since both semaphores 32A and 32B have reached their respective wait threshold values 34A and 34B, the synchronization block 22 is further configured to transmit a wait completion response 54 to the first hardware accelerator block 24A. The wait completion response 54 includes the local semaphore identifiers 35A and 35B of the semaphores 32A and 32B.

FIG. 3C shows an example timeline in which the wait request 30 is included among a plurality of wait requests 30 indicating the semaphore 32 that are received at the synchronization block 22. As shown in FIG. 3C, the synchronization block 22 is configured to receive a wait request 30A from the first hardware accelerator block 24A and receive a wait request 30B from a second hardware accelerator block 24B. The wait requests 30A and 30B both include the same semaphore 32, wait threshold value 34, and local semaphore identifier 35. The wait threshold value is equal to 1 in the example of FIG. 3C.

The synchronization block 22 is further configured to receive a signal request 50, including a global semaphore identifier 36 of the semaphore 32, from a signal source block 42. In response to receiving the signal request 50, the synchronization block 22 is further configured to update the semaphore 32. This update brings the semaphore 32 to its wait threshold value 34. Since both the first hardware accelerator block 24A and the second hardware accelerator block 24B have submitted wait requests that indicate the semaphore 32, the synchronization block 22 is configured to transmit the wait completion response 54 to both the first hardware accelerator block 24A and the second hardware accelerator block 24B.

Although, in the examples of FIGS. 3A-3C, the signal requests 50 are locally sourced signal requests that include global semaphore identifiers 36, the signal requests 50 may alternatively be remote signal requests that include respective translated memory addresses 38.

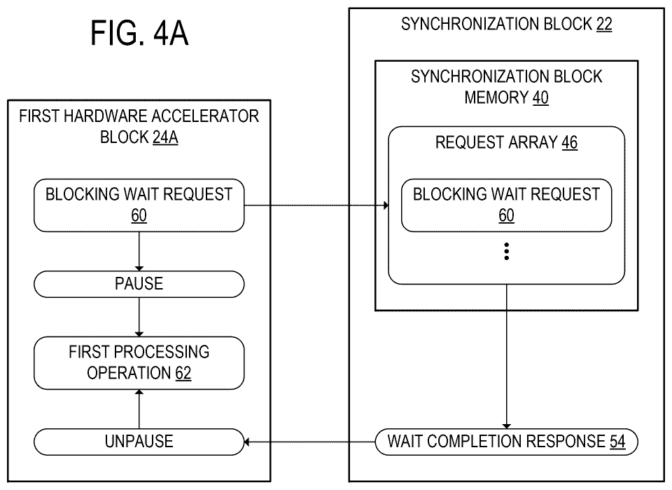

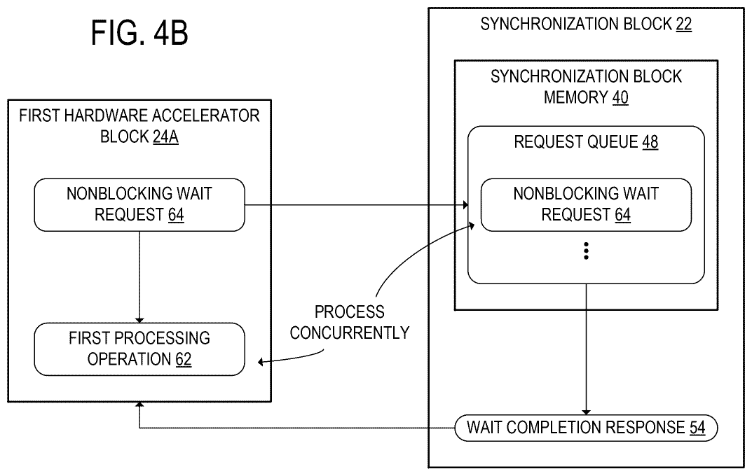

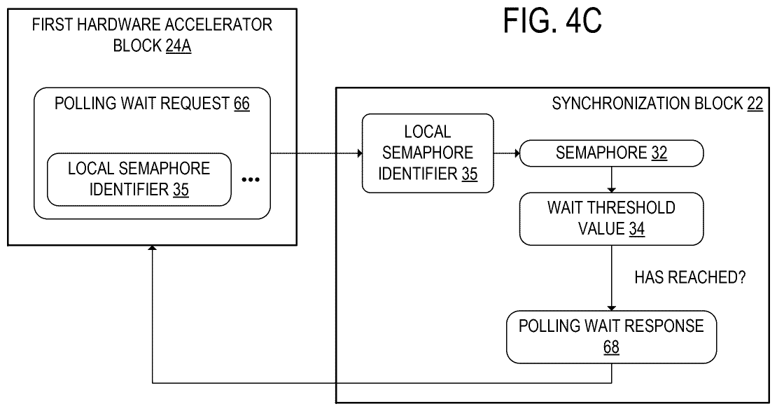

FIGS. 4A-4C show examples of different types of wait requests 30 that may be received at the synchronization block 22. In the example of FIG. 4A, the wait request 30 is a blocking wait request 60. Subsequently to transmitting the blocking wait request 60 to the synchronization block 22, the first hardware accelerator block 24A is further configured to pause a first processing operation 62 until the first hardware accelerator block 24A receives the wait completion response 54. The first hardware accelerator block 24A is further configured to resume the first processing operation 62 in response to receiving the wait completion response 54. For example, the first processing operation 62 may take, as input, the output of a second processing operation performed at another hardware accelerator block 24. The first hardware accelerator block 24A may accordingly issue a blocking wait request 60 to the synchronization block 22 so that the synchronization block 22 notifies the first hardware accelerator block 24A with the wait completion response 54 when the input from the other hardware accelerator block is ready for the first hardware accelerator block 24A to consume. In this example, the first processing operation 62 is paused until the wait completion response 54 is received.

FIG. 4B shows an example in which the wait request 30 is a nonblocking wait request 64. In the example of FIG. 4B, subsequently to transmitting the nonblocking wait request 64 to the synchronization block 22, the first hardware accelerator block 24A is further configured to perform the first processing operation 62 concurrently with processing of the nonblocking wait request 64 at the synchronization block 22. By issuing a nonblocking wait request 64, the first hardware accelerator block 24A is therefore configured to continue a first processing operation 62 that does not depend upon an additional input from another hardware accelerator block 24. The nonblocking wait request 64 is stored in a request queue 48 within the synchronization block memory 40 in this example.

In the example of FIG. 4C, the synchronization block 22 is configured to receive a polling wait request 66 from the first hardware accelerator block 24A. The polling wait request 66 includes a local semaphore identifier 35 of the one or more local semaphore identifiers 35. In response to receiving the polling wait request 66, the synchronization block 22 is further configured to transmit, to the first hardware accelerator block 24A, a polling wait response 68 that indicates whether the semaphore 32 indicated by the local semaphore identifier 35 has reached the wait threshold value 34. In some examples, the polling wait response 68 is a Boolean value. The value of the semaphore 32 may alternatively be included in the polling wait response 68 in some examples. The first hardware accelerator block 24A may issue a polling wait request 66 in order to quickly check whether a semaphore 32 has reached its wait threshold value 34.

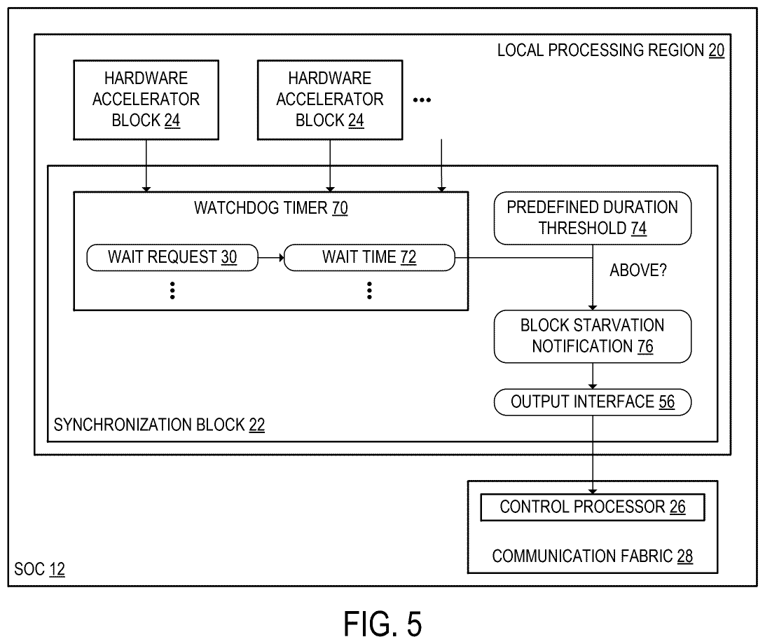

FIG. 5 schematically shows the synchronization block 22 in an example in which the synchronization block includes a watchdog timer 70. The watchdog timer 70 is configured to measure respective wait times 72 of the local hardware accelerator blocks 24 included in the local processing region 20. The wait times 72 are the durations for which wait requests 30 have been pending at the synchronization block 22. For example, the wait times 72 may be measured in clock cycles of processing circuitry included in the synchronization block 22.

In the example of FIG. 5, the synchronization block 22 is further configured to determine that the wait time 72 of a local hardware accelerator block 24 exceeds a predefined duration threshold 74. In response to determining that the wait time 72 exceeds the predefined duration threshold 74, the synchronization block 22 is further configured to transmit a block starvation notification 76 to the control processor 26 included in the SoC 12. In this example, the synchronization block 22 is configured to transmit the block starvation notification 76 to the control processor 26 over the output interface 56 of the synchronization block 22 and across the communication fabric 28 of the SoC 12. The synchronization block 22 is accordingly configured to output a software-level notification that the local hardware accelerator block is taking longer than expected to receive a requested wait completion response 54. The block starvation notification 76 may, for example, be used in a debugging process when searching for a software error that leads to hardware accelerator block starvation.

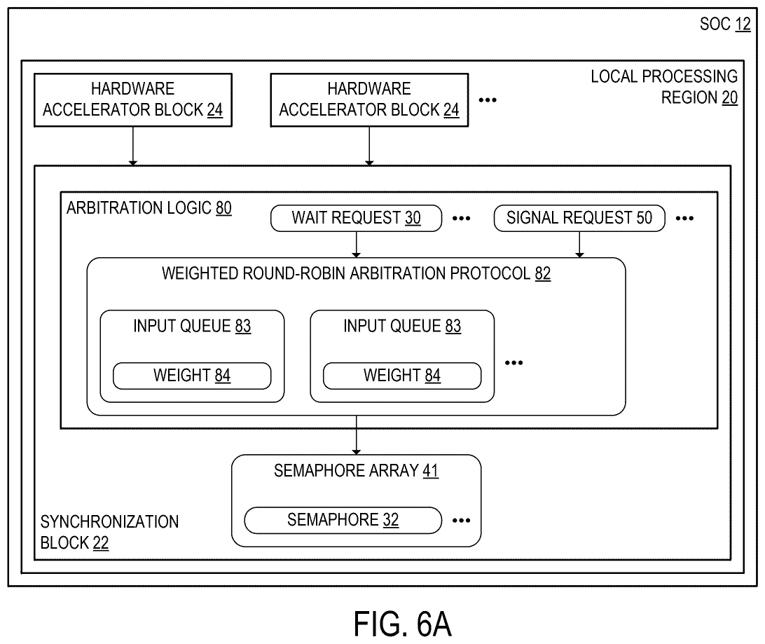

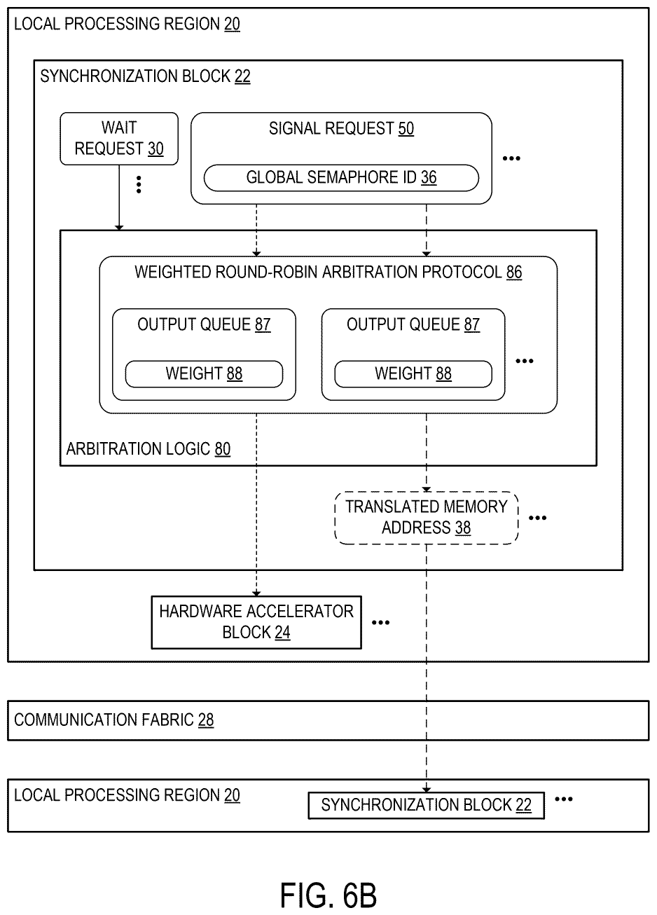

FIGS. 6A-6B schematically show the synchronization block 22 in an example in which the synchronization block 22 further includes arbitration logic 80. FIG. 6A shows the synchronization block 22 when the arbitration logic 80 receives a plurality of incoming wait requests 30. Additionally or alternatively, the arbitration logic 80 may be configured to receive a plurality of incoming signal requests 50. At the arbitration logic 80, the synchronization block 22 is further configured to process the plurality of wait requests 30 and/or signal requests 50 according to a weighted round-robin arbitration protocol 82. The weighted round-robin arbitration protocol 82 may be classical weighted round-robin arbitration or interleaved weighted round-robin arbitration. The arbitration logic 80 includes a plurality of input queues 83 to which the wait requests 30 and/or signal requests 50 are assigned, with each input queue 83 having a respective weight 84. The weights 84 may indicate respective priority levels of the queues 83. The synchronization block 22 may accordingly be configured to share its processing capacity among the local hardware accelerator blocks 24 in an approximately even manner.

The weights 84 of the input queues 83 may correspond to different types of requests processed at the synchronization block 22. For example, an input queue 83 that receives signal requests 50 may have a higher weight 84 than an input queue 83 that receives wait requests 30, since signal requests 50 are used to unblock wait requests 30. A queue 83 that receives polling wait requests 66 may in turn have a higher weight 84 than the queue 83 that receives signal requests 50, since polling wait requests 66 are configured to be answered with low latency.

The arbitration logic 80 may additionally or alternatively be used to perform processor sharing for outgoing wait requests 30 and/or signal requests 50, as shown in the example of FIG. 6B. The synchronization block 22 is configured to execute a weighted round-robin arbitration protocol 86 that includes a plurality of output queues 87. The output queues 87 have respective weights 88, which may indicate different priority levels. The weights 88 may correspond to outgoing request types associated with the output queues 87. Thus, the synchronization block 22 is configured to share its processing capacity between a plurality of signal requests 50.

When the synchronization block 22 transmits a signal request 50 over the communication fabric 28 to another synchronization block 22 outside its local processing region 20, the synchronization block 22 may be further configured to compute a translated memory address 38 based at least in part on the global semaphore identifier 36 of the outgoing signal request 50. When the signal request 50 is instead transmitted to a hardware accelerator block 24 inside the same local processing region 20, the global semaphore identifier 36 may be left untranslated. By computing translated memory addresses 38 for signal requests 50 to remote processing regions, the synchronization block 22 converts the global semaphore identifier 36 into a form that is usable at the remote synchronization block 22 to select a semaphore 32.

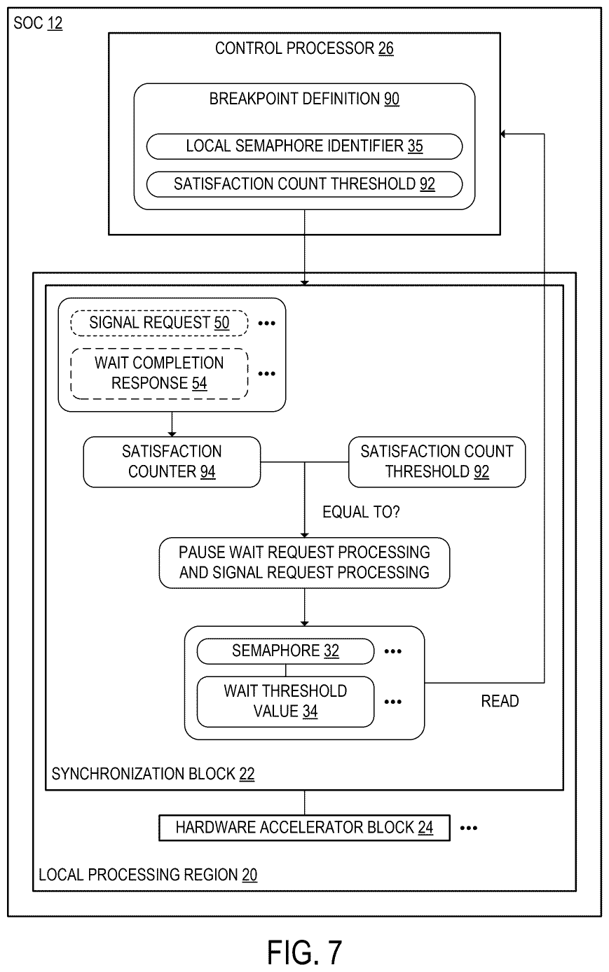

In some examples, the synchronization blocks 22 of the SoC 12 are used to implement breakpoints that allow debugging to be performed. FIG. 7 schematically shows the SoC 12 in an example in which the synchronization block 22 is further configured to receive a breakpoint definition 90. The breakpoint definition 90 is received from the control processor 26 in the example of FIG. 7. In this example, the breakpoint definition 90 includes the local semaphore identifier 35 of a semaphore 32. The breakpoint definition 90 further includes a satisfaction count threshold 92.

Subsequently to receiving the breakpoint definition 90, the synchronization block 22 is further configured to determine that the semaphore 32 indicated by the local semaphore identifier 35 has been specified in a number of signal requests 50 or wait completion responses 54 equal to the satisfaction count threshold 92. The breakpoint definition 90 may be a signal breakpoint definition in which the satisfaction count threshold 92 is a specific number of signal requests or may alternatively be a wait breakpoint definition in which the satisfaction count threshold 92 is a specific number of wait completion responses 54.

In response to determining that the semaphore 32 has been specified in a number of signal requests 50 or wait completion responses 54 equal to the satisfaction count threshold 92, the synchronization block 22 is further configured to pause wait request processing and signal request processing at the synchronization block 22. The synchronization block 22 may, for each breakpoint definition 90, be further configured to store a satisfaction counter 94 that tracks the number of signal requests 50 or wait completion responses 54 to the semaphore 32 for which the breakpoint definition 90 has been specified. The synchronization block 22 may be further configured to pause when the satisfaction counter 94 is equal to the satisfaction count threshold 92. Accordingly, the synchronization block 22 is configured to pause when the synchronization block 22 receives a number of signal requests 50 or wait completion responses 54 that potentially indicates a software error. For example, a large number of signal requests 50 or wait completion responses 54 associated with a specific semaphore 32 may indicate that a computing process executed at the SoC 12 is stuck in a loop.

While the wait request processing and the signal request processing are paused, the control processor 26 included in the SoC 12 may be further configured to read the respective values of the one or more semaphores 32 and/or the one or more wait threshold values 34 associated with the one or more semaphores 32. The control processor 26 may accordingly perform diagnostic read operations at the synchronization block 22 to obtain values that may be used to detect a source of a software error. Other values stored at the synchronization block 22 may additionally or alternatively be read by the control processor 26 in other examples.

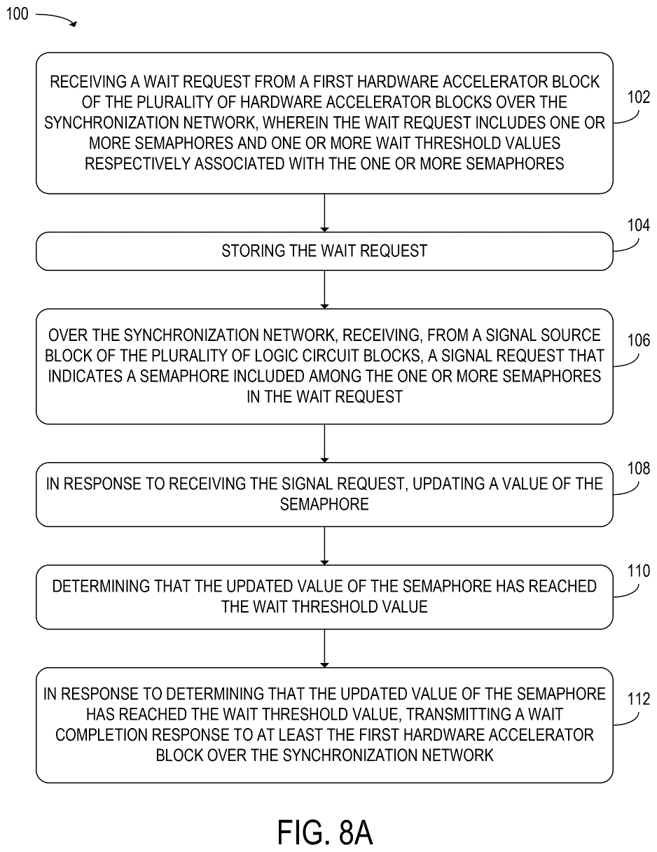

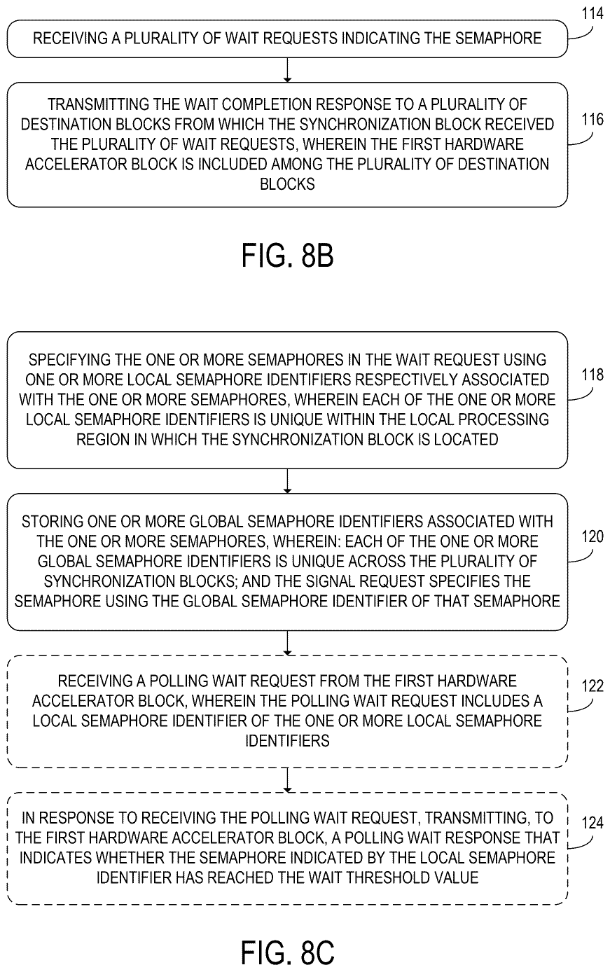

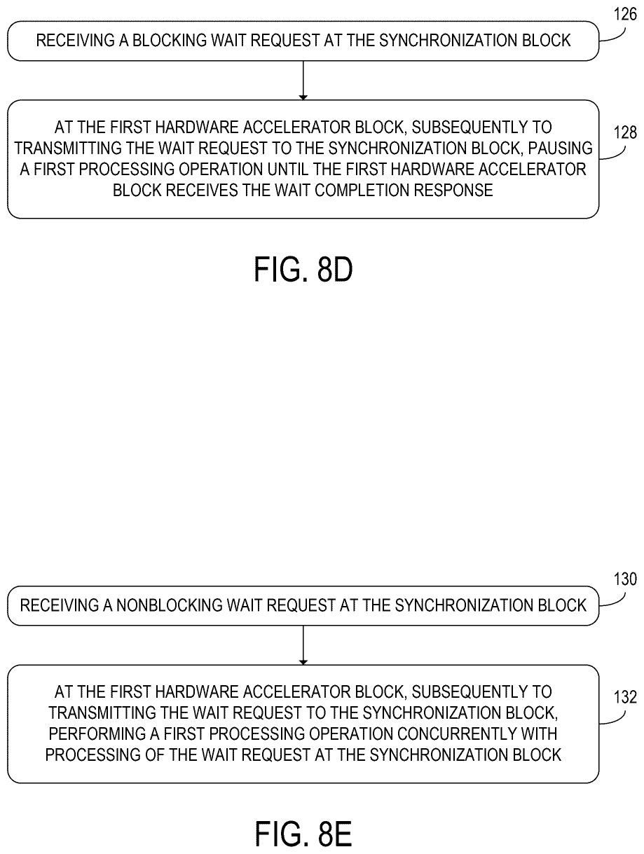

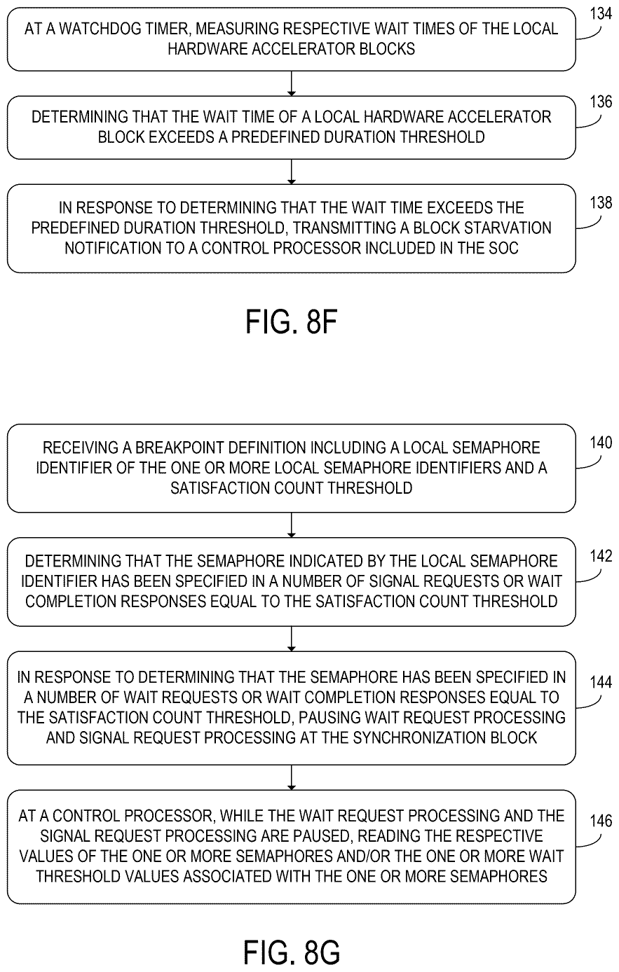

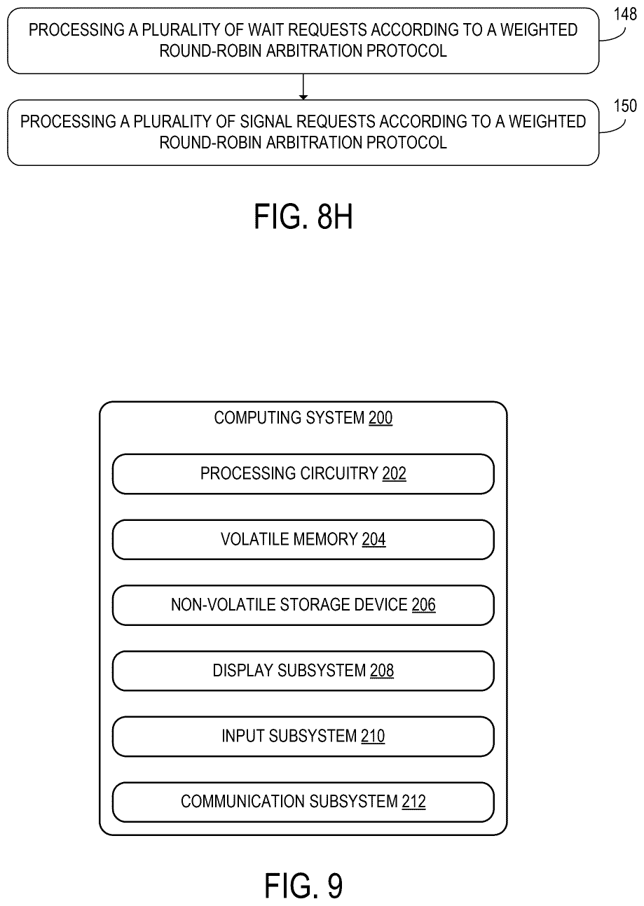

FIG. 8A shows a flowchart of a method 100 for use with a computing system. The computing system includes an SoC, which includes a plurality of logic circuit blocks. The plurality of logic circuit blocks include a plurality of synchronization blocks and a plurality of hardware accelerator blocks arranged in a synchronization network. In some examples, the synchronization network is arranged in a plurality of local processing regions that each include a respective synchronization block of the plurality of synchronization blocks. In such examples, each local processing region further includes a respective plurality of local hardware accelerator blocks coupled to the synchronization block. The local processing regions are coupled to each other via the synchronization blocks.

The steps shown in FIG. 8A are performed at a synchronization block of the plurality of synchronization blocks. At step 102, the method 100 includes receiving a wait request from a first hardware accelerator block of the plurality of hardware accelerator blocks. The wait request is received over the synchronization network. In some examples, each of the synchronization blocks is eligible to receive the wait request from within the local processing region of the synchronization block and not from outside the local processing region of the synchronization block. The wait request includes one or more semaphores and one or more wait threshold values respectively associated with the one or more semaphores. Each of the semaphores may, for example, be an integer-valued counter, and each of the wait threshold values may also be integer-valued. At step 104, the method 100 further includes storing the wait request in synchronization block memory.

At step 106, the method 100 further includes receiving, from a signal source block of the plurality of logic circuit blocks, a signal request that indicates a semaphore included among the one or more semaphores in the wait request. The signal request is also received over the synchronization network. In examples in which the hardware accelerator blocks are grouped into local processing regions, each of the synchronization blocks may be eligible to receive the signal request from within the local processing region of the synchronization block and from outside the local processing region of the synchronization block.

At step 108, the method 100 further includes updating a value of the semaphore in response to receiving the signal request. In some examples, the synchronization block may increment or decrement the semaphore to count up or down in the direction of the wait threshold value.

In some examples, rather than receiving the wait request prior to the signal request, as in the example of FIG. 8A, the synchronization block may receive and store the signal request prior to receiving the wait request. In such examples, the semaphore may be updated at step 108 in response to receiving the wait request instead of in response to receiving the signal request.

At step 110, the method 100 further includes determining that the updated value of the semaphore has reached the wait threshold value. At step 112, in response to determining that the updated value of the semaphore has reached the wait threshold value, the method 100 further includes transmitting a wait completion response to at least the first hardware accelerator block over the synchronization network. Thus, the first hardware accelerator is notified that the wait associated with the semaphore is complete.

FIGS. 8B-8H show additional steps of the method 100 that may be performed in some examples. At step 114, the method 100 may further include receiving a plurality of wait requests indicating the semaphore. The plurality of wait requests may be received from a respective plurality of hardware accelerator blocks included in the local processing region of the synchronization block. At step 116, the method 100 may further include transmitting the wait completion response to a plurality of destination blocks from which the synchronization block received the plurality of wait requests. The first hardware accelerator block is included among the plurality of destination blocks.

In the example of FIG. 8C, at step 118, the method 100 may further include specifying the one or more semaphores in the wait request using one or more local semaphore identifiers respectively associated with the one or more semaphores. Each of the one or more local semaphore identifiers is unique within the local processing region in which the synchronization block is located.

At step 120, the method 100 may further include storing one or more global semaphore identifiers associated with the one or more semaphores. Each of the one or more global semaphore identifiers is unique across the plurality of synchronization blocks. In addition, the signal request may specify the semaphore using the global semaphore identifier of that semaphore. In some examples, when a signal request is sent to another synchronization block outside the local processing region, the synchronization block may perform memory address translation to convert the global semaphore identifier into a memory address.

In examples in which step 118 is performed, the method 100 may further include, at step 122, receiving a polling wait request from the first hardware accelerator block. The polling wait request may include a local semaphore identifier of the one or more local semaphore identifiers. In such examples, at step 124, the method 100 may further include transmitting a polling wait response to the first hardware accelerator block in response to receiving the polling wait request. The polling wait response indicates whether the semaphore indicated by the local semaphore identifier has reached the wait threshold value.

FIGS. 8D and 8E show steps of the method 100 when other types of wait requests are received at step 102. In the example of FIG. 8D, the method 100 may further include, at step 126, receiving a blocking wait request at the synchronization block. At step 128, subsequently to transmitting the wait request to the synchronization block, the method 100 may further include, at the first hardware accelerator block, pausing a first processing operation until the first hardware accelerator block receives the wait completion response.

In the example of FIG. 8E, the method 100 may further include, at step 130, receiving a nonblocking wait request at the synchronization block. At step 132, subsequently to transmitting the wait request to the synchronization block, the method 100 may further include, at the first hardware accelerator block, performing a first processing operation concurrently with processing of the wait request at the synchronization block. Thus, in contrast to the example of FIG. 8D, the nonblocking wait request does not pause the first processing operation when issued.

FIG. 8F shows steps that may be performed at the synchronization block in examples in which the synchronization block includes a watchdog timer. At step 134, the method 100 may further include measuring respective wait times of the local hardware accelerator blocks at the watchdog timer. At step 136, the method 100 may further include determining that the wait time of a local hardware accelerator block exceeds a predefined duration threshold. In response to determining that the wait time exceeds the predefined duration threshold, the method 100 may further include, at step 138, transmitting a block starvation notification to a control processor included in the SoC. The control processor may therefore be notified when completion of a wait request is taking longer than expected, a condition that may indicate a software error.

FIG. 8G shows additional steps that may be performed in some examples as part of a debugging protocol. At step 140, the method 100 may further include receiving a breakpoint definition. The breakpoint definition may include a local semaphore identifier of the one or more local semaphore identifiers and may further include a satisfaction count threshold. The breakpoint definition may be a wait breakpoint definition or a signal breakpoint definition.

At step 142, the method 100 may further include determining that the semaphore indicated by the local semaphore identifier has been specified in a number of signal requests (when the breakpoint definition is a signal breakpoint definition) or wait completion responses (when the breakpoint definition is a wait breakpoint definition) equal to the satisfaction count threshold. Reaching the satisfaction count threshold may indicate that a potential software error has occurred.

At step 144, in response to determining that the semaphore has been specified in a number of wait requests or signal requests equal to the satisfaction count threshold, the method 100 may further include pausing wait request processing and signal request processing at the synchronization block. At step 146, while the wait request processing and the signal request processing are paused, the method 100 may further include reading the respective values of the one or more semaphores and/or the one or more wait threshold values associated with the one or more semaphores. Step 146 may be performed at a control processor of the SoC. The control processor may transmit the respective values of the one or more semaphores and/or the one or more wait threshold values to another component of the computing system. Accordingly, those values may be utilized in one or more additional steps of a debugging process.

FIG. 8H shows additional steps of the method 100 that may be performed in some examples. At step 148, the method 100 may further include processing a plurality of wait requests according to a weighted round-robin arbitration protocol. Classical or interleaved weighted round-robin arbitration may be used to prioritize the processing of different wait requests.

At step 150, the method 100 may further include processing a plurality of signal requests according to a weighted round-robin arbitration protocol. These signal requests may be outgoing signal requests. A different set of weights from those used in the processing of the wait requests may be used at the queues of the weighted round-robin arbitration protocol used to process the signal requests. The signal requests may be prioritized using classical or interleaved weighted round-robin arbitration.

The devices and methods discussed above use synchronization blocks of a SoC as specialized hardware components that handle wait requests and signal requests for the other hardware accelerators included in the SoC. By using a synchronization block, communication between the hardware accelerators and the control processor of the SoC may be reduced, thereby freeing up the processing capabilities of the control processor for other tasks and avoiding bottlenecks at the control processor. The synchronization block may also provide a unified semaphore protocol for the hardware accelerators, thereby avoiding additional processing and potential software errors that may occur when translating between the semaphore protocols.

The methods and processes described herein are tied to a computing system of one or more computing devices. In particular, such methods and processes can be implemented as a computer-application program or service, an application-programming interface (API), a library, and/or other computer-program product.

FIG. 9 schematically shows a non-limiting embodiment of a computing system 200 that can enact one or more of the methods and processes described above. Computing system 200 is shown in simplified form. Computing system 200 may embody the computing device 10 described above and illustrated in FIG. 1. Components of computing system 200 may be included in one or more personal computers, server computers, tablet computers, home-entertainment computers, network computing devices, video game devices, mobile computing devices, mobile communication devices (e.g., smartphone), and/or other computing devices, and wearable computing devices such as smart wristwatches and head mounted augmented reality devices.

Computing system 200 includes processing circuitry 202, volatile memory 204, and a non-volatile storage device 206. Computing system 200 may optionally include a display subsystem 208, input subsystem 210, communication subsystem 212, and/or other components not shown in FIG. 9.

Processing circuitry 202 typically includes one or more logic processors, which are physical devices configured to execute instructions. For example, the logic processors may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the processing circuitry 202 may be single-core or multi-core, and the instructions executed thereon may be configured for sequential, parallel, and/or distributed processing. Individual components of the processing circuitry 202 optionally may be distributed among two or more separate devices, which may be remotely located and/or configured for coordinated processing. For example, aspects of the computing system 200 disclosed herein may be virtualized and executed by remotely accessible, networked computing devices configured in a cloud-computing configuration. In such a case, these virtualized aspects are run on different physical logic processors of various different machines, it will be understood. These different physical logic processors of the different machines will be understood to be collectively encompassed by processing circuitry 202.

Non-volatile storage device 206 includes one or more physical devices configured to hold instructions executable by the processing circuitry to implement the methods and processes described herein. When such methods and processes are implemented, the state of non-volatile storage device 206 may be transformed—e.g., to hold different data.

Non-volatile storage device 206 may include physical devices that are removable and/or built in. Non-volatile storage device 206 may include optical memory, semiconductor memory, and/or magnetic memory, or other mass storage device technology. Non-volatile storage device 206 may include nonvolatile, dynamic, static, read/write, read-only, sequential-access, location-addressable, file-addressable, and/or content-addressable devices. It will be appreciated that non-volatile storage device 206 is configured to hold instructions even when power is cut to the non-volatile storage device 206.

Volatile memory 204 may include physical devices that include random access memory. Volatile memory 204 is typically utilized by processing circuitry 202 to temporarily store information during processing of software instructions. It will be appreciated that volatile memory 204 typically does not continue to store instructions when power is cut to the volatile memory 204.

Aspects of processing circuitry 202, volatile memory 204, and non-volatile storage device 206 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 200 typically implemented in software by a processor to perform a particular function using portions of volatile memory 204, which function involves transformative processing that specially configures the processor to perform the function. Thus, a module, program, or engine may be instantiated via processing circuitry 202 executing instructions held by non-volatile storage device 206, using portions of volatile memory 204. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 208 may be used to present a visual representation of data held by non-volatile storage device 206. The visual representation may take the form of a graphical user interface (GUI). As the herein described methods and processes change the data held by the non-volatile storage device, and thus transform the state of the non-volatile storage device, the state of display subsystem 208 may likewise be transformed to visually represent changes in the underlying data. Display subsystem 208 may include one or more display devices utilizing virtually any type of technology. Such display devices may be combined with processing circuitry 202, volatile memory 204, and/or non-volatile storage device 206 in a shared enclosure, or such display devices may be peripheral display devices.

When included, input subsystem 210 may comprise or interface with one or more user-input devices such as a keyboard, mouse, touch screen, camera, or microphone.

When included, communication subsystem 212 may be configured to communicatively couple various computing devices described herein with each other, and with other devices. Communication subsystem 212 may include wired and/or wireless communication devices compatible with one or more different communication protocols. As non-limiting examples, the communication subsystem may be configured for communication via a wired or wireless local- or wide-area network, broadband cellular network, etc. In some embodiments, the communication subsystem may allow computing system 200 to send and/or receive messages to and/or from other devices via a network such as the Internet.

The following paragraphs discuss several aspects of the present disclosure. According to one aspect of the present disclosure, a computing device is provided, including a system-on-a-chip (SoC) including a plurality of logic circuit blocks. The plurality of logic circuit blocks include a plurality of synchronization blocks and a plurality of hardware accelerator blocks arranged in a synchronization network. A synchronization block of the plurality of synchronization blocks is configured to receive a wait request from a first hardware accelerator block of the plurality of hardware accelerator blocks over the synchronization network. The wait request includes one or more semaphores and one or more wait threshold values respectively associated with the one or more semaphores. The synchronization block is further configured to store the wait request. Over the synchronization network, the synchronization block is further configured to receive, from a signal source block of the plurality of logic circuit blocks, a signal request that indicates a semaphore included among the one or more semaphores in the wait request. In response to receiving the signal request, the synchronization block is further configured to update a value of the semaphore. The synchronization block is further configured to determine that the updated value of the semaphore has reached the wait threshold value. In response to determining that the updated value of the semaphore has reached the wait threshold value, the synchronization block is further configured to transmit a wait completion response to at least the first hardware accelerator block over the synchronization network. The above features may have the technical effect of performing hardware accelerator synchronization at the hardware level using a unified semaphore protocol.

According to this aspect, the synchronization network may be arranged in a plurality of local processing regions that each include a respective synchronization block of the plurality of synchronization blocks and a respective plurality of local hardware accelerator blocks coupled to the synchronization block. The local processing regions are coupled via the synchronization blocks. The above features may have the technical effect of performing hardware-level synchronization for different regions of the SoC in parallel with each other.

According to this aspect, each of the synchronization blocks may be eligible to receive the wait request from within the local processing region of the synchronization block and not from outside the local processing region of the synchronization block. Each of the synchronization blocks may be eligible to receive the signal request from within the local processing region of the synchronization block and from outside the local processing region of the synchronization block. The above features may have the technical effect of reducing average communication distances across the SoC while still allowing signaling between different regions.

According to this aspect, the synchronization block may be further configured to measure respective wait times of the local hardware accelerator blocks at a watchdog timer. The synchronization block may be further configured to determine that the wait time of a local hardware accelerator block exceeds a predefined duration threshold. In response to determining that the wait time exceeds the predefined duration threshold, the synchronization block may be further configured to transmit a block starvation notification to a control processor included in the SoC. The above features may have the technical effect of detecting errors that result in long wait times for the hardware accelerator blocks.

According to this aspect, the wait request may specify the one or more semaphores using one or more local semaphore identifiers respectively associated with the one or more semaphores. Each of the one or more local semaphore identifiers may be unique within the local processing region in which the synchronization block is located. The above features may have the technical effect of preventing errors in hardware accelerator synchronization that would otherwise occur due to treating different semaphores as the same semaphore.

According to this aspect, the synchronization block may be further configured to store one or more global semaphore identifiers associated with the one or more semaphores. Each of the one or more global semaphore identifiers may be unique across the plurality of local processing regions. The signal request may specify the semaphore using the global semaphore identifier of that semaphore. The above features may have the technical effect of making the semaphores specified in the signal requests distinguishable from each other.

According to this aspect, the synchronization block may be further configured to receive a polling wait request from the first hardware accelerator block. The polling wait request may include a local semaphore identifier of the one or more local semaphore identifiers. In response to receiving the polling wait request, the synchronization block may be further configured to transmit, to the first hardware accelerator block, a polling wait response that indicates whether the semaphore indicated by the local semaphore identifier has reached the wait threshold value. The above features may have the technical effect of allowing the first hardware accelerator block to quickly check whether a semaphore has reached its wait threshold value.

According to this aspect, the synchronization block may be further configured to receive a breakpoint definition including a local semaphore identifier of the one or more local semaphore identifiers and a satisfaction count threshold. The synchronization block may be further configured to determine that the semaphore indicated by the local semaphore identifier has been specified in a number of signal requests or wait completion responses equal to the satisfaction count threshold. In response to determining that the semaphore has been specified in a number of signal requests or wait completion responses equal to the satisfaction count threshold, the synchronization block may be further configured to pause wait request processing and signal request processing at the synchronization block. The above features may have the technical effect of detecting, and pausing processing in response to, errors that result in high numbers of signal requests or wait completion responses.

According to this aspect, while the wait request processing and the signal request processing are paused, a control processor included in the SoC may be configured to read the respective values of the one or more semaphores and/or the one or more wait threshold values associated with the one or more semaphores. The above features may have the technical effect of collecting additional information that may be used to diagnose and correct the error that resulted in pausing wait request processing and signal processing.

According to this aspect, the synchronization block may be further configured to process a plurality of wait requests and/or signal requests according to a weighted round-robin arbitration protocol. The above features may have the technical effect of sharing the processing capacity of the synchronization block across the local hardware accelerator blocks in an approximately even manner.

According to this aspect, the wait request may be included among a plurality of wait requests indicating the semaphore that are received at the synchronization block. The synchronization block may be configured to transmit the wait completion response to a plurality of destination blocks from which the synchronization block received the plurality of wait requests. The first hardware accelerator block is included among the plurality of destination blocks. The above features may have the technical effect of allowing multiple hardware accelerator blocks to wait on a specific semaphore.

According to this aspect, the wait request may be a blocking wait request. Subsequently to transmitting the wait request to the synchronization block, the first hardware accelerator block may be further configured to pause a first processing operation until the first hardware accelerator block receives the wait completion response. The above features may have the technical effect of using wait requests and wait completion responses to determine when the first processing operation is paused and resumed.

According to this aspect, the wait request may be a nonblocking wait request. Subsequently to transmitting the wait request to the synchronization block, the first hardware accelerator block is further configured to perform a first processing operation concurrently with processing of the wait request at the synchronization block. The above features may have the technical effect of performing the first processing operation in parallel with waiting for the wait completion response.

According to another aspect of the present disclosure, a method for use with a computing system that includes a system-on-a-chip (SoC) is provided. The SoC includes a plurality of logic circuit blocks. The plurality of logic circuit blocks include a plurality of synchronization blocks and a plurality of hardware accelerator blocks arranged in a synchronization network. The method includes, at a synchronization block of the plurality of synchronization blocks, receiving a wait request from a first hardware accelerator block of the plurality of hardware accelerator blocks over the synchronization network. The wait request includes one or more semaphores and one or more wait threshold values respectively associated with the one or more semaphores. The method further includes storing the wait request. The method further includes, over the synchronization network, receiving, from a signal source block of the plurality of logic circuit blocks, a signal request that indicates a semaphore included among the one or more semaphores in the wait request. In response to receiving the signal request, the method further includes updating a value of the semaphore. The method further includes determining that the updated value of the semaphore has reached the wait threshold value. In response to determining that the updated value of the semaphore has reached the wait threshold value, the method further includes transmitting a wait completion response to at least the first hardware accelerator block over the synchronization network. The above features may have the technical effect of performing hardware accelerator synchronization at the hardware level using a unified semaphore protocol.

According to this aspect, the synchronization network may be arranged in a plurality of local processing regions that each include a respective synchronization block of the plurality of synchronization blocks and a respective plurality of local hardware accelerator blocks coupled to the synchronization block. The local processing regions may be coupled via the synchronization blocks. The above features may have the technical effect of performing hardware-level synchronization for different regions of the SoC in parallel with each other.

According to this aspect, each of the synchronization blocks may be eligible to receive the wait request from within the local processing region of the synchronization block and not from outside the local processing region of the synchronization block. Each of the synchronization blocks may be eligible to receive the signal request from within the local processing region of the synchronization block and from outside the local processing region of the synchronization block. The above features may have the technical effect of reducing average communication distances across the SoC while still allowing signaling between different regions.

According to this aspect, the method may further include, at the synchronization block, specifying the one or more semaphores in the wait request using one or more local semaphore identifiers respectively associated with the one or more semaphores. Each of the one or more local semaphore identifiers is unique within the local processing region in which the synchronization block is located. The method may further include storing one or more global semaphore identifiers associated with the one or more semaphores. Each of the one or more global semaphore identifiers may be unique across the plurality of synchronization blocks. The signal request may specify the semaphore using the global semaphore identifier of that semaphore. The above features may have the technical effect of preventing errors in hardware accelerator synchronization that would otherwise occur due to treating different semaphores as the same semaphore.

According to this aspect, the method may further include, at the synchronization block receiving a breakpoint definition including a local semaphore identifier of the one or more local semaphore identifiers and a satisfaction count threshold. The method may further include determining that the semaphore indicated by the local semaphore identifier has been specified in a number of signal requests or wait completion responses equal to the satisfaction count threshold. In response to determining that the semaphore has been specified in a number of signal requests or wait completion responses equal to the satisfaction count threshold, the method may further include pausing wait request processing and signal request processing at the synchronization block. The above features may have the technical effect of detecting, and pausing processing in response to, errors that result in high numbers of signal requests or wait completion responses.

According to this aspect, the wait request may be included among a plurality of wait requests indicating the semaphore that are received at the synchronization block. At the synchronization block, the method may further include transmitting the wait completion response to a plurality of destination blocks from which the synchronization block received the plurality of wait requests. The first hardware accelerator block may be included among the plurality of destination blocks. The above features may have the technical effect of allowing multiple hardware accelerator blocks to wait on a specific semaphore.

According to another aspect of the present disclosure, a synchronization block included in a system-on-a-chip (SoC) is provided. The synchronization block is configured to receive a plurality of wait requests from a plurality of hardware accelerator blocks included in the SoC. Each wait request of the one or more wait requests includes one or more semaphores and one or more wait threshold values respectively associated with the one or more semaphores. The synchronization block is further configured to store the wait requests. The synchronization block is further configured to receive a plurality of signal requests. Each of the signal requests indicates at least one semaphore included in one or more of the wait requests. In response to receiving each of the signal requests, the synchronization block is further configured to update a respective value of the at least one semaphore indicated in that signal request. For each wait request of the plurality of wait requests, the synchronization block is further configured to determine that the one or more respective updated values of the one or more semaphores included in the wait request have reached the one or more wait threshold values associated with the one or more semaphores. In response to determining that the one or more respective updated values have reached the one or more wait threshold values, the synchronization block is further configured to transmit a wait completion response to a hardware accelerator block from which the synchronization block received the wait request. The above features may have the technical effect of performing hardware accelerator synchronization at the hardware level using a unified semaphore protocol.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing device comprising:
a system-on-a-chip (SoC) including a plurality of logic circuit blocks, wherein:
the plurality of logic circuit blocks include a plurality of synchronization blocks and a plurality of hardware accelerator blocks arranged in a synchronization network; and
a synchronization block of the plurality of synchronization blocks is configured to:
receive a wait request from a first hardware accelerator block of the plurality of hardware accelerator blocks over the synchronization network, wherein the wait request includes one or more semaphores and one or more wait threshold values respectively associated with the one or more semaphores;
store the wait request;
over the synchronization network, receive, from a signal source block of the plurality of logic circuit blocks, a signal request that indicates a semaphore included among the one or more semaphores in the wait request;
in response to receiving the signal request, update a value of the semaphore;
determine that the updated value of the semaphore has reached the wait threshold value; and
in response to determining that the updated value of the semaphore has reached the wait threshold value, transmit a wait completion response to at least the first hardware accelerator block over the synchronization network.

2. The computing device of claim 1, wherein:
the synchronization network is arranged in a plurality of local processing regions that each include:
a respective synchronization block of the plurality of synchronization blocks; and
a respective plurality of local hardware accelerator blocks coupled to the synchronization block; and
the local processing regions are coupled via the synchronization blocks.

3. The computing device of claim 2, wherein:
each of the synchronization blocks is eligible to receive the wait request from within the local processing region of the synchronization block and not from outside the local processing region of the synchronization block; and
each of the synchronization blocks is eligible to receive the signal request from within the local processing region of the synchronization block and from outside the local processing region of the synchronization block.

4. The computing device of claim 2, wherein the synchronization block is further configured to:
at a watchdog timer, measure respective wait times of the local hardware accelerator blocks;
determine that the wait time of a local hardware accelerator block exceeds a predefined duration threshold; and
in response to determining that the wait time exceeds the predefined duration threshold, transmit a block starvation notification to a control processor included in the SoC.

5. The computing device of claim 2, wherein:
the wait request specifies the one or more semaphores using one or more local semaphore identifiers respectively associated with the one or more semaphores; and
each of the one or more local semaphore identifiers is unique within the local processing region in which the synchronization block is located.

6. The computing device of claim 5, wherein:
the synchronization block is further configured to store one or more global semaphore identifiers associated with the one or more semaphores;
each of the one or more global semaphore identifiers is unique across the plurality of local processing regions; and
the signal request specifies the semaphore using the global semaphore identifier of that semaphore.

7. The computing device of claim 6, wherein:
the synchronization block is further configured to receive a polling wait request from the first hardware accelerator block;
the polling wait request includes a local semaphore identifier of the one or more local semaphore identifiers; and
in response to receiving the polling wait request, the synchronization block is further configured to transmit, to the first hardware accelerator block, a polling wait response that indicates whether the semaphore indicated by the local semaphore identifier has reached the wait threshold value.

8. The computing device of claim 5, wherein the synchronization block is further configured to:
receive a breakpoint definition including:
a local semaphore identifier of the one or more local semaphore identifiers; and
a satisfaction count threshold;
determine that the semaphore indicated by the local semaphore identifier has been specified in a number of signal requests or wait completion responses equal to the satisfaction count threshold; and
in response to determining that the semaphore has been specified in a number of signal requests or wait completion responses equal to the satisfaction count threshold, pause wait request processing and signal request processing at the synchronization block.

9. The computing device of claim 8, wherein, while the wait request processing and the signal request processing are paused, a control processor included in the SoC is configured to read:
the respective values of the one or more semaphores; and/or
the one or more wait threshold values associated with the one or more semaphores.

10. The computing device of claim 1, wherein the synchronization block is further configured to process a plurality of wait requests and/or signal requests according to a weighted round-robin arbitration protocol.

11. The computing device of claim 1, wherein:
the wait request is included among a plurality of wait requests indicating the semaphore that are received at the synchronization block;
the synchronization block is configured to transmit the wait completion response to a plurality of destination blocks from which the synchronization block received the plurality of wait requests; and
the first hardware accelerator block is included among the plurality of destination blocks.

12. The computing device of claim 1, wherein:
the wait request is a blocking wait request; and
subsequently to transmitting the wait request to the synchronization block, the first hardware accelerator block is further configured to pause a first processing operation until the first hardware accelerator block receives the wait completion response.

13. The computing device of claim 1, wherein:
the wait request is a nonblocking wait request; and
subsequently to transmitting the wait request to the synchronization block, the first hardware accelerator block is further configured to perform a first processing operation concurrently with processing of the wait request at the synchronization block.

14. A method for use with a computing system that includes a system-on-a-chip (SoC), wherein:
the SoC includes a plurality of logic circuit blocks; and
the plurality of logic circuit blocks include a plurality of synchronization blocks and a plurality of hardware accelerator blocks arranged in a synchronization network, the method comprising, at a synchronization block of the plurality of synchronization blocks:
receiving a wait request from a first hardware accelerator block of the plurality of hardware accelerator blocks over the synchronization network, wherein the wait request includes one or more semaphores and one or more wait threshold values respectively associated with the one or more semaphores;
storing the wait request;
over the synchronization network, receiving, from a signal source block of the plurality of logic circuit blocks, a signal request that indicates a semaphore included among the one or more semaphores in the wait request;
in response to receiving the signal request, updating a value of the semaphore;
determining that the updated value of the semaphore has reached the wait threshold value; and
in response to determining that the updated value of the semaphore has reached the wait threshold value, transmitting a wait completion response to at least the first hardware accelerator block over the synchronization network.

15. The method of claim 14, wherein:
the synchronization network is arranged in a plurality of local processing regions that each include:
a respective synchronization block of the plurality of synchronization blocks; and
a respective plurality of local hardware accelerator blocks coupled to the synchronization block; and
the local processing regions are coupled via the synchronization blocks.

16. The method of claim 15, wherein:
each of the synchronization blocks is eligible to receive the wait request from within the local processing region of the synchronization block and not from outside the local processing region of the synchronization block; and
each of the synchronization blocks is eligible to receive the signal request from within the local processing region of the synchronization block and from outside the local processing region of the synchronization block.

17. The method of claim 15, further comprising, at the synchronization block:
specifying the one or more semaphores in the wait request using one or more local semaphore identifiers respectively associated with the one or more semaphores, wherein each of the one or more local semaphore identifiers is unique within the local processing region in which the synchronization block is located; and
storing one or more global semaphore identifiers associated with the one or more semaphores, wherein:
each of the one or more global semaphore identifiers is unique across the plurality of synchronization blocks; and
the signal request specifies the semaphore using the global semaphore identifier of that semaphore.

18. The method of claim 17, further comprising, at the synchronization block:
receiving a breakpoint definition including:
a local semaphore identifier of the one or more local semaphore identifiers; and
a satisfaction count threshold;
determining that the semaphore indicated by the local semaphore identifier has been specified in a number of signal requests or wait completion responses equal to the satisfaction count threshold; and
in response to determining that the semaphore has been specified in a number of signal requests or wait completion responses equal to the satisfaction count threshold, pausing wait request processing and signal request processing at the synchronization block.

19. The method of claim 14, wherein:
the wait request is included among a plurality of wait requests indicating the semaphore that are received at the synchronization block;
at the synchronization block, the method further comprises transmitting the wait completion response to a plurality of destination blocks from which the synchronization block received the plurality of wait requests; and
the first hardware accelerator block is included among the plurality of destination blocks.

20. A synchronization block included in a system-on-a-chip (SoC), wherein the synchronization block is configured to:
receive a plurality of wait requests from a plurality of hardware accelerator blocks included in the SoC, wherein each wait request of the one or more wait requests includes one or more semaphores and one or more wait threshold values respectively associated with the one or more semaphores;
store the wait requests;
receive a plurality of signal requests, wherein each of the signal requests indicates at least one semaphore included in one or more of the wait requests;
in response to receiving each of the signal requests, update a respective value of the at least one semaphore indicated in that signal request; and
for each wait request of the plurality of wait requests:
determine that the one or more respective updated values of the one or more semaphores included in the wait request have reached the one or more wait threshold values associated with the one or more semaphores; and
in response to determining that the one or more respective updated values have reached the one or more wait threshold values, transmit a wait completion response to a hardware accelerator block from which the synchronization block received the wait request.
